(19) United States
(12) Patent Application Publication
(10) Pub. No.: US 2001/0014193 A1
(43) Pub. Date: Aug. 16, 2001

(54) OPTICAL COUPLER WITH WAVELENGHT AND POLARIZATION MULTIPLEXERS

(76) Inventor: TAKASHI SHIBUYA, TOKYO (JP)

Correspondence Address: MCGINN & GIBB, SUITE 100, 1701 CLARENDON BOULEVARD, ARLINGTON, VA, 22201

(21) Appl. No.: 09/063,293

(22) Filed: Apr. 21, 1998

(30) Foreign Application Priority Data
Apr. 21, 1997 (JP) 103069/1997

(51) Int. Cl. G02B 6/26

(52) U.S. Cl. 385/15; 385/24; 385/11

(57) ABSTRACT

Disclosed is an optical coupler which has: a first wavelength-multiplexing means for wavelength-multiplexing first pumping light with a first linear polarization direction and a first wavelength and second pumping light with the first linear polarization direction and a second wavelength and for outputting first output light with the first linear polarization direction; a second wavelength-multiplexing means for wavelength-multiplexing third pumping light with a second linear polarization direction orthogonal to the first linear polarization direction and the first wavelength and fourth pumping light with the second linear polarization direction and the second wavelength and for outputting second output light with the second linear polarization direction; and a polarization-multiplexing means for polarization-multiplexing the first output light output from the first wavelength-multiplexing means and the second output light output from the second wavelength-multiplexing means.

### FIELD OF THE INVENTION

This invention relates to an optical coupler used in optical communications, and more particularly to, an optical coupler for multiplexing pumping lights to be applied to an optical fiber amplifier.

### BACKROUND OF THE INVENTION

One of the conventional techniques to achieve a long-distance optical communication is to increase the output power of a light source on transmit side. As a device for increasing the output power, optical fiber amplifiers to amplify the transmission power are used. For example, Ishio et al., “Optical Amplifier and The Applications”, Ohm corp., p. 184, 1992 describes about the light source amplification on transmit side by using optical amplifiers.

To increase the output of an optical fiber amplifier, the output power of pumping light source needs to be increased.

For example, Japanese patent application laid-open No. 4-25825(1992) (hereinafter referred to as ‘Prior art 1’) discloses an optical fiber amplifier with optical coupler as means for increasing the output power of the pumping light source. The optical coupler provided for the optical fiber amplifier in prior art 1, as shown in FIG. 1, comprises a first polarization multiplexer 14 to combine lights through polarization plane holding type optical fibers from two pumping light sources 65, 66, a second polarization multiplexer 15 to combine lights through polarization plane holding type optical fibers from two pumping light sources 67, 68, and a wavelength multiplexer 51 to combine the light outputs from the first and second polarization multiplexers 14, 15. Thus, the output power of the entire optical fiber amplifier in prior art 1 provided with such a optical coupler can be increased by using the output light from the optical coupler as a light source to amplify the signal light.

However, there are several problems in the optical coupler in prior art 1.

In general, an erbium-doped optical fiber amplifier composed of EDF (erbium-doped fiber). which is also used in prior art 1 as shown in FIG. 1, is typically used as an optical fiber amplifier. The pumping-light wavelength band of the erbium-doped optical fiber amplifier is 1450 nm to 1500 nm, while the wavelength band of signal light is 1550 nm. Thus, several pumping lights combined to produce the high-power pumping light from the erbium-doped optical fiber are selected from 1460 nm or 1490 nm wavelength light.

Also, dielectric multilayer film is typically used in polarization-multiplexing and wavelength-multiplexing. In general, for polarization multiplexing film, it is desired that the transmittance wavelength characteristic of P-polarized light is apart as far as possible from the transmittance wavelength characteristic of S-polarized light. Here, P-polarized light means light with a polarization direction on the plane that includes the orthogonal vector of dielectric multilayer film and the direction vector of incident light, and S-polarized light means light with a polarization direction orthogonal to P-polarized light. On the contrary, for wavelength multiplexing film, it is desired that the transmittance wavelength characteristics of P-polarized light and S-polarized light come as close as possible to each other.

However, in dielectric multilayer film, the transmittance wavelength characteristics of P-polarized light and S-polarized light are, in general, different from each other except the case of an incidence angle of 0°, and it is difficult to make them close to each other or to reduce the difference therebetween. Especially, when the incidence angle is increased, the characteristic difference between P-polarized light and S-polarized light becomes big.

From the above viewpoints, the polarization multiplexer in prior art 1 only have to have such a characteristic as shown in FIG. 8, while the wavelength multiplexer in prior art 1 needs to have such a characteristic as shown in FIG. 2 that, as to both P-polarized light and S-polarized light, for example, light with a wavelength of 1460 nm is substantially 100% transmitted and light with a wavelength of 1490 nm is substantially 100% reflected. Namely, needed for the wavelength multiplexer in prior art 1 is dielectric multilayer film that has a steep wavelength characteristic with a narrow wavelength range where the transmittance varies from 100% to 0%. To get dielectric multilayer film with such a steep wavelength characteristic, the number of dielectric layers to be vapor-deposited has to be increased. Also, to produce such dielectric multilayer film constantly, a special apparatus that can control the stable vapor deposition is necessary. Thus, the dielectric multilayer film required in prior art 1 is costly and difficult to produce.

Meanwhile, Japanese patent application laid-open Nos. 63-115145(1988) (hereinafter referred to as ‘prior art 2’) and 64-18132(1989) (hereinafter referred to as ‘prior art 2’) disclose the other examples of an optical coupler for multiplexing four pumping lights.

In prior art 2, both the functions of two polarization multiplexers 14, 15 and a wavelength multiplexer 51 are, as shown in FIG. 3, integrated. Also, in prior art 3, both the functions of two wavelength multiplexers 52, 53 and a polarization multiplexer 16 are, as shown in FIG. 4, integrated.

However, neither of prior art 2 and prior art 3 takes the above conditions of dielectric multilayer film into account while they have different compositions. Namely, they are not effective inventions to match the wavelength characteristic etc. of dielectric multilayer film in practical use while both of them are effective only for wavelength-multiplexing and polarization-multiplexing by ideal dielectric multilayer film.

Thus, neither of prior art 2 and prior art 3 can relax the condition of the wavelength characteristic of dielectric multilayer film in practical use.

### SUMMARY OF THE INVENTION

Accordingly, it is an object of the invention to provide an optical coupler that can relax the condition of the wavelength characteristic of dielectric multilayer film in practical use.

According to the invention, an optical coupler, comprises:

a first wavelength-multiplexing means for wavelength-multiplexing first pumping light with a first linear polarization direction and a first wavelength and second pumping light with the first linear polarization direction and a second wavelength and for outputting first output light with the first linear polarization direction;

a second wavelength-multiplexing means for wavelength-multiplexing third pumping light with a second linear polarization direction orthogonal to the first linear polarization direction and the first wavelength and fourth pumping light with the second linear polarization direction and the second wavelength and for outputting second output light with the second linear polarization direction; and

a polarization-multiplexing means for polarization-multiplexing the first output light output from the first wavelength-multiplexing means and the second output light output from the second wavelength-multiplexing means.

### BRIEF DESCRIPTION OF THE DRAWINGS

The invention will be explained in more detail in conjunction with the appended drawings, wherein:

FIG. 1 is an illustration showing an optical fiber amplifier provided with an optical coupler in prior art 1,

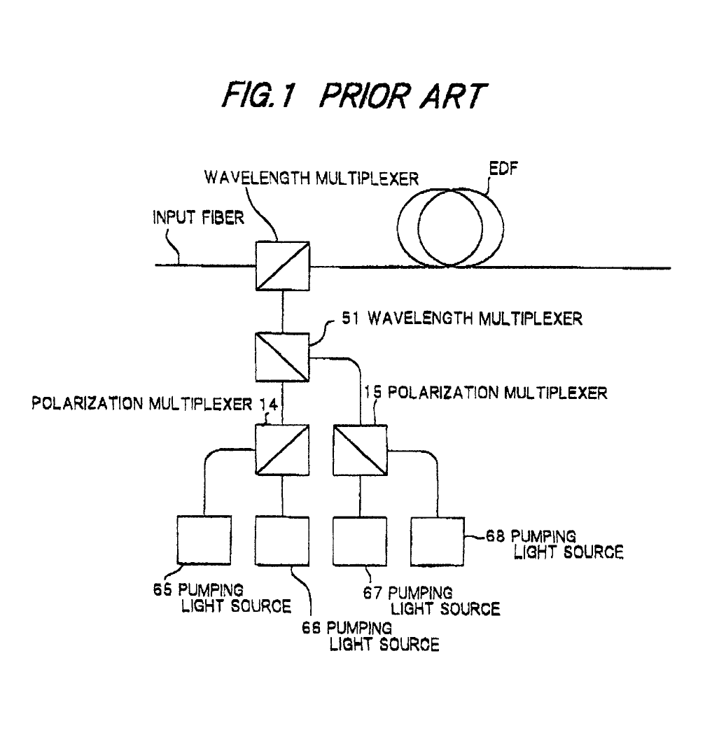

FIG. 2 is a graph showing a transmittance wavelength characteristic required in the wavelength-multiplexer of the optical coupler in prior art 1,

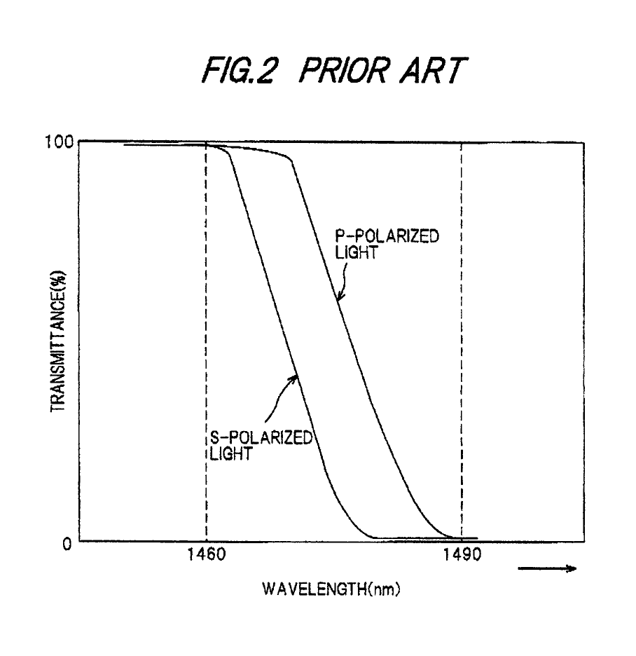

FIG. 3 is an illustration showing an optical coupler in prior art 2,

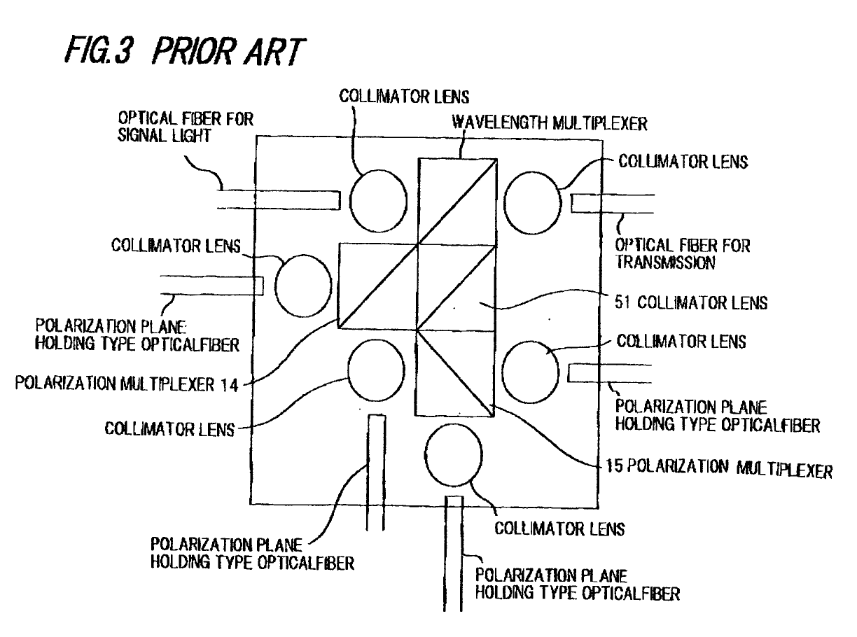

FIG. 4 is an illustration showing an optical coupler in prior art 3,

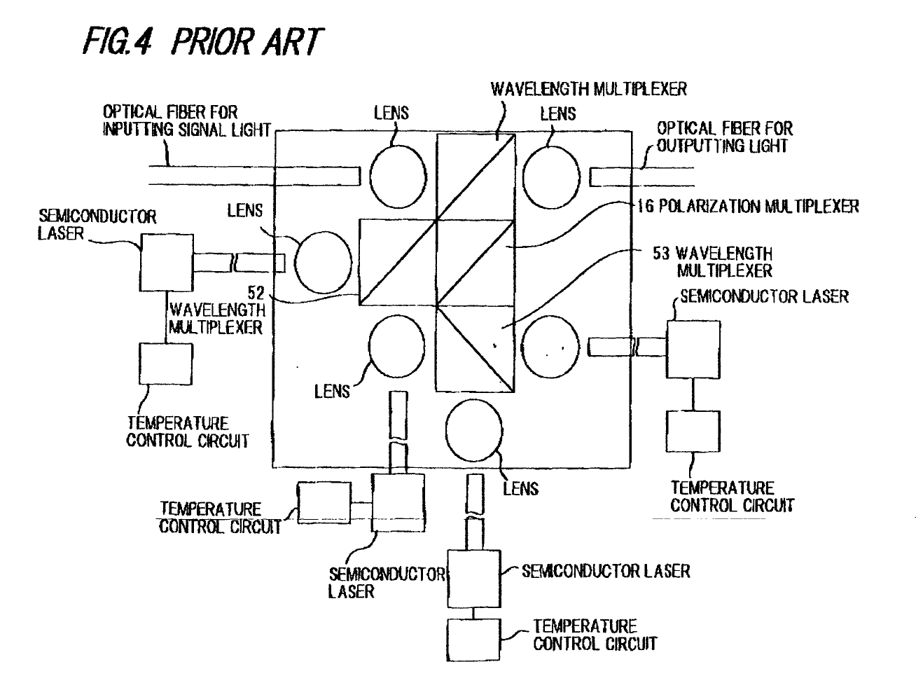

FIG. 5 is an illustration showing an optical coupler in a first preferred embodiment according to the invention,

FIG. 6 is a graph showing the transmittance wavelength characteristic of a first wavelength-multiplexing film 1 in FIG. 5,

FIG. 7 is a graph showing the transmittance wavelength characteristic of a second wavelength-multiplexing film 2 in FIG. 5,

FIG. 8 is a graph showing the transmittance wavelength characteristic of a polarization-multiplexing film 11 in FIG. 5,

FIG. 9 is an illustration showing an optical coupler in a second preferred embodiment according to the invention,

FIG. 10 is a graph showing the transmittance wavelength characteristic of a first wavelength-multiplexing film 1 in FIG. 9,

FIG. 11 is a graph showing the transmittance wavelength characteristic of a second wavelength-multiplexing film 2 in FIG. 9,

FIG. 12 is an illustration showing an optical coupler in a third preferred embodiment according to the invention,

FIG. 13 is a graph showing the transmittance wavelength characteristic of a first long-wave pass type wavelength-multiplexing film 3 in FIG. 12,

FIG. 14 is a graph showing the transmittance wavelength characteristic of a second long-wave pass type wavelength-multiplexing film 4 in FIG. 12,

FIG. 15 is an illustration showing an optical coupler in a fourth preferred embodiment according to the invention,

FIG. 16 is an illustration showing an optical coupler in a fifth preferred embodiment according to the invention,

FIG. 17 is an illustration showing an optical coupler in a sixth preferred embodiment according to the invention,

FIG. 18 is an illustration showing an optical coupler in a seventh preferred embodiment according to the invention, and

FIG. 19 is an illustration showing an optical coupler in an eighth preferred embodiment according to the invention,

### DESCRIPTION OF THE PREFERRED EMBODIMENTS

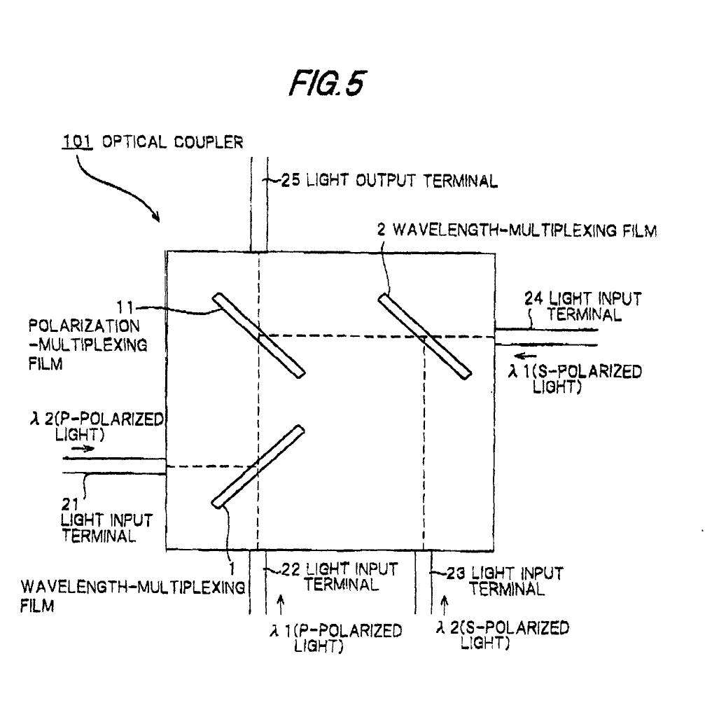

An optical coupler in the first preferred embodiment will be explained in FIG. 5.

An optical coupler 101 in the first embodiment, as shown in FIG. 5. comprises first to fourth light input terminals 21 to 24 provided with polarization plane holding type optical fibers, first and second wavelength-multiplexing films 1, 2, polarization-multiplexing film 11, and a light output terminal 25 provided with a single-mode optical fiber. Meanwhile, the polarization plane holding type optical fiber is used to transmit linear polarized light in the main polarization axis direction.

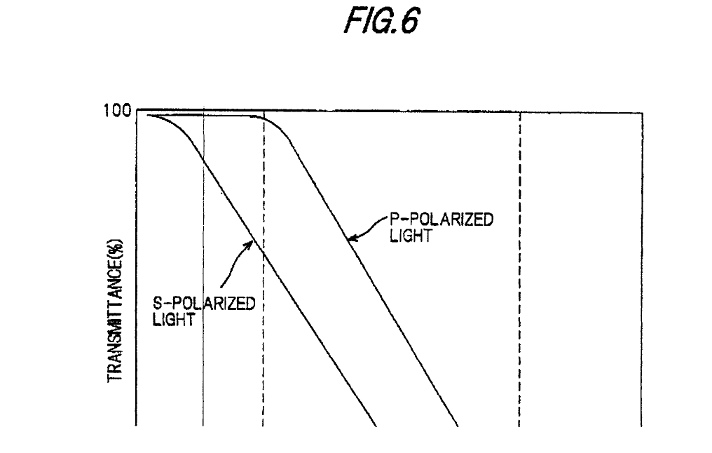

The first wavelength-multiplexing film 1 has such a transmittance wavelength characteristic as shown in FIG. 6 and is dielectric multilayer film with the function of multiplexing incident light with a wavelength of ^{λ}1 (P-polarized light) and incident light with a wavelength of ^{λ}2 (P-polarized light) at an incidence angle of 45°. In detail, as shown in FIG. 6, it has the characteristic that light with a wavelength of ^{λ}1 (P-polarized light) is substantially 100% transmitted and light with a wavelength of ^{λ}2 (P-polarized light) is substantially 100% reflected. On the other hand, it has the characteristic that S-polarized light cannot be sufficiently transmitted at a wavelength of ^{λ}1. Namely, it will be appreciated that the first wavelength-multiplexing film 1 can sufficiently function as means for multiplexing incident light with a wavelength of ^{λ}1 and incident light with a wavelength of ^{λ}2 only when P-polarized light is supplied thereto. Thus, when incident light with a wavelength of ^{λ}2 (P-polarized light) is supplied from the first light input terminal 21 and incident light with a wavelength of ^{λ}1 (P-polarized light) is supplied from the second light input terminal 22, the first wavelength-multiplexing film 1 combines the two incident lights and then outputs P-polarized light to the polarization-multiplexing film 11. Meanwhile, such wavelength-multiplexing film that transmits short-wave incident light and reflects long-wave incident light like the first wavelength-multiplexing film 1 is called “short-wave pass type”.

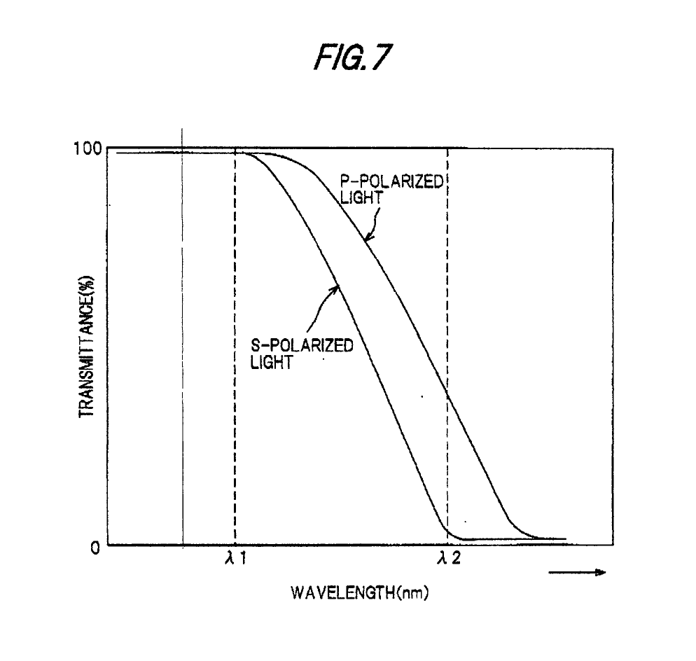

The second wavelength-multiplexing film 2 has such a transmittance wavelength characteristic as shown in FIG. 7 and is dielectric multilayer film with the function of multiplexing incident light with a wavelength of ^{λ}1 (S-polarized light) and incident light with a wavelength of ^{λ}2 (S-polarized light) at an incidence angle of 45°. In detail, as shown in FIG. 7, it has the characteristic that light with a wavelength of ^{λ}1 (S-polarized light) is substantially 100% transmitted and light with a wavelength of ^{λ}2 (S-polarized light) is substantially 100% reflected. On the other hand, it has the characteristic that P-polarized light cannot be sufficiently reflected at a wavelength of ^{λ}2. Namely, it will be appreciated that the second wavelength-multiplexing film 2 can sufficiently function as means for multiplexing incident light with a wavelength of ^{λ}1 and incident light with a wavelength of ^{λ}2 only when S-polarized light is supplied thereto. Thus, when incident light with a wavelength of ^{λ}2 (S-polarized light) is supplied from the third light input terminal 23 and incident light with a wavelength of ^{λ}1 (S-polarized light) is supplied from the fourth light input terminal 24, the second wavelength-multiplexing film 2 combines the two incident lights and then outputs S-polarized light to the polarization-multiplexing film 11. Meanwhile, the second wavelength-multiplexing film 2 is also called “short-wave pass type” like the first wavelength-multiplexing film 1.

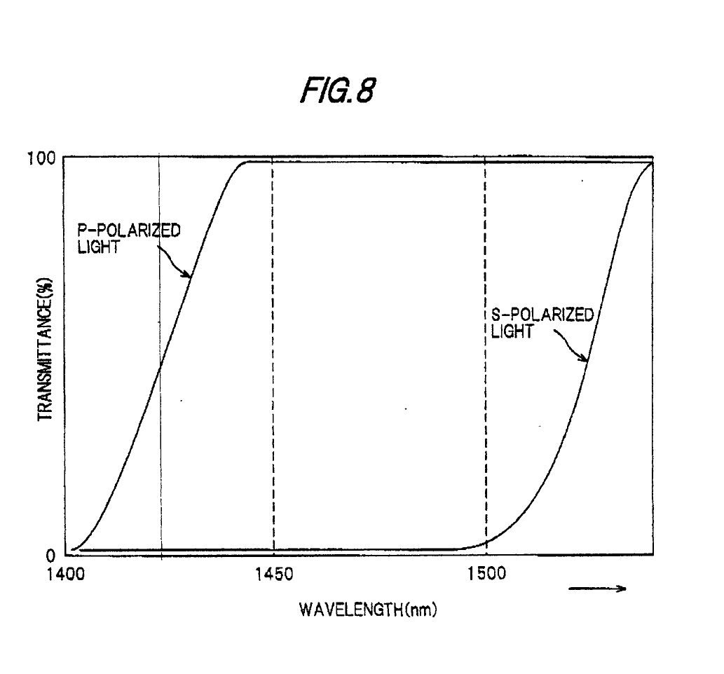

The polarization-multiplexing film 11 has such a transmittance wavelength characteristic as shown in FIG. 8 and is dielectric multilayer film with the function of polarization-multiplexing P-polarized incident light and S-polarized incident light in the range of about 1450 to 1500 nm at an incidence angle of 45°. In detail, as shown in FIG. 8, it has the characteristic that P-polarized light is substantially 100% transmitted and S-polarized light is substantially 100% reflected in the range of about 1450 to 1500 nm. Thus, the polarization-multiplexing film 11 can polarization-combine P-polarized light to be obtained wavelength-multiplexing by the first wavelength-multiplexing film 1 and S-polarized light to be obtained wavelength-multiplexing by the second wavelength-multiplexing film 2, then outputting light obtained multiplexing the four incident lights, in total, to the light output terminal 25.

In the optical coupler 101 in the first embodiment, it will be appreciated from FIGS. 6 and 7 that the first and second wavelength-multiplexing films 1, 2 only have to be effective as a wavelength-multiplexing means to P-polarized light or S-polarized light. Namely, such a steep transmittance wavelength characteristic as in prior art I is not required. On the other hand, light to be output from the optical coupler 101 can be obtained multiplexing the four incident lights.

Thus, in the first embodiment, the optical coupler with high output power can be obtained by using low-cost and easily-available dielectric multilayer film.

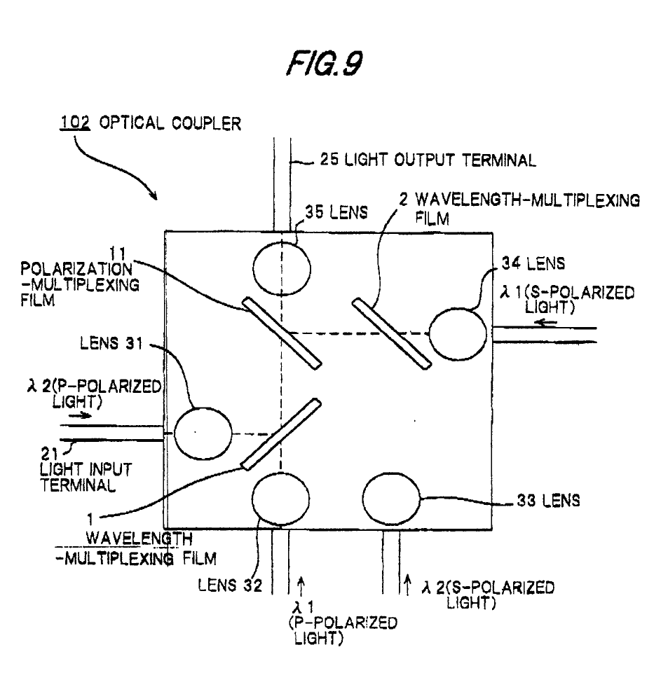

An optical coupler in the second preferred embodiment, which is given as a specific example of the optical coupler in the first embodiment, will be explained in FIGS. 9 to 11.

An optical coupler 102 in the second embodiment, as shown in FIG. 9, comprises first to fourth light input terminals 21 to 24 provided with polarization plane holding type optical fibers, first to fourth lenses 31 to 34 provided corresponding to the first to fourth light input terminals 21 to 24, first and second wavelength-multiplexing films 1, 2, polarization-multiplexing film 11, a light output terminal 25 provided with a single-mode optical fiber, and a fifth lens 35 provided corresponding to the light output terminal 25.

The first to fifth lenses 31 to 35 are collimator lenses for converting incident light into collimated light,

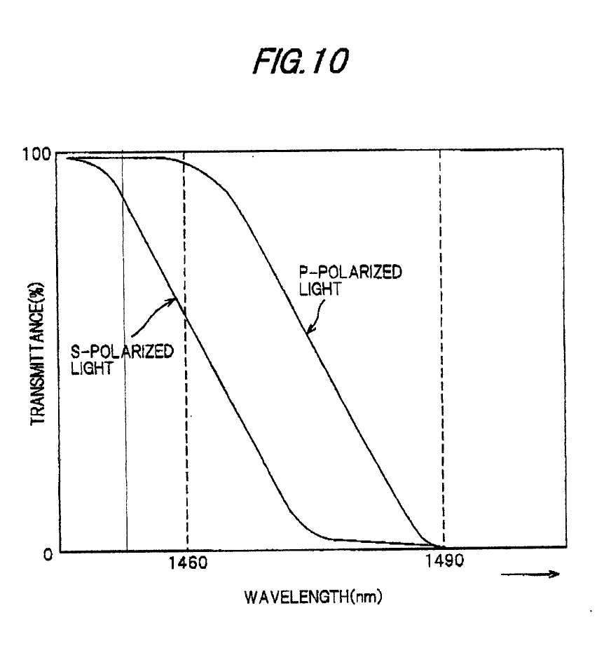

The first wavelength-multiplexing film 1 is a short-wave pass type wavelength-multiplexing means that is, as shown in FIG. 10, effective only for incident light with a wavelength of ^{λ}1=1460 nm and incident light with a wavelength of A₂=1490 nm as P-polarized lights at an incidence angle of 45°. In detail, as understood from FIG. 10, the first wavelength-multiplexing film 1 has the characteristics that, at an incidence angle of 45°, P-polarized light with a wavelength of 1460 nm is more than 95% transmitted, P-polarized light with a wavelength of 1490 nm is less than 1% transmitted and S-polarized light with a wavelength of 1460 nm is about 60% transmitted. Thus, it can effectively conduct the wavelength-multiplexing only for incident lights with wavelengths of ^{λ}1=1460 am and ^{λ}2=1490 nm as P-polarized lights.

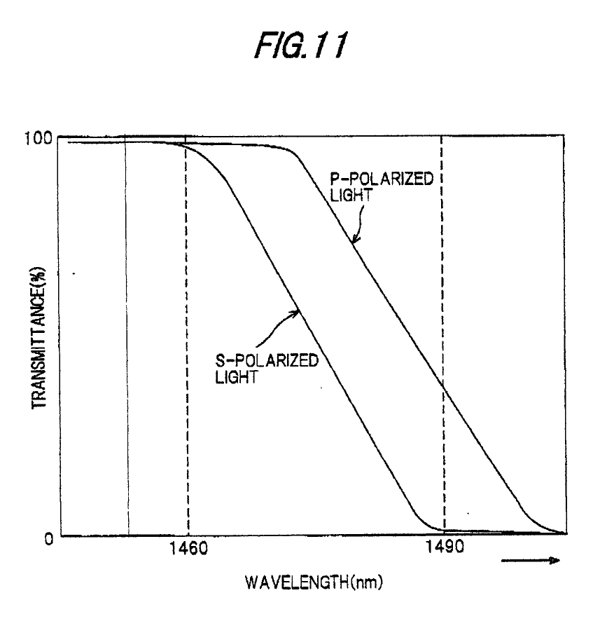

On the other hand, the second wavelength-multiplexing film 2 is a short-wave pass type wavelength-multiplexing means that is as shown in FIG. 11, effective only for incident light with a wavelength of ^{λ}11460 nm and incident light with a wavelength of ^{λ}2=1490 nm as S-polarized lights at an incidence angle of 45°. In detail, as understood from FIG. 11, the second wavelength-multiplexing film 2 has the characteristics that, at an incidence angle of 45°, S-polarized light with a wavelength of 1460 nm is more than 95% transmitted, S-polarized light with a wavelength of 1490 nm is less than 1% transmitted and P-polarized light with a wavelength of 1490 nm is about 40% transmitted. Thus, it can effectively conduct the wavelength-multiplexing only for incident lights with wavelengths of ^{λ}1=1460 nm and ^{λ}2=1490 nm as S-polarized lights.

The polarization-multiplexing film 11 has such a transmittance wavelength characteristic as shown in FIG. 8 line that in the first embodiment.

Meanwhile, the first and second wavelength-multiplexing films 1, 2 and the polarization-multiplexing film 11 are formed by vapor-depositing the dielectric multilayer onto a glass substrate, and are so designed and fabricated that the above-mentioned characteristics can be obtained at an incidence angle of 45°. For example, the first and second wavelength-multiplexing films may be composed by layering several dielectric thin layers of silica or titania on a substrate, such as quartz glass. The number of layers needed for the wavelength-multiplexing film in the second embodiment can be reduced due to the wavelength characteristic, while the number of dielectric layers must be increased to obtain the wavelength characteristic needed in prior art 1 and it is therefore difficult to fabricate constantly and cheaply.

In the optical coupler 102 in the second embodiment, when first pumping light with a wavelength of 1490 nm (P-polarized light) from the first light input terminal 21, second pumping light with a wavelength of 1460 nm (P-polarized light) from the second light input terminal 22, third pumping light with a wavelength of 1490 nm (S-polarized light) from the third light input terminal 23, and fourth pumping light with a wavelength of 1460 nm (S-polarized light) from the fourth light input terminal 24 are supplied, the first to fourth pumping lights are combined and then output from the light output terminal 25 as explained below. Namely, the first wavelength-multiplexing film 1 reflects the first pumping light supplied through the first lens 31 as well as transmitting the second pumping light supplied through the second lens 32, thereby wavelength-multiplexing the first and second pumping lights and then outputting the P-polarized combined light to the polarization-multiplexing film 11. The second wavelength-multiplexing film 2 reflects the third pumping light supplied through the third lens 33 as well as transmitting the fourth pumping light supplied through the fourth lens 34, thereby wavelength-multiplexing the third and fourth pumping lights and then outputting the S-polarized combined light to the polarization-multiplexing film 11. Then, the polarization-multiplexing film 11 transmits the P-polarized light supplied from the first wavelength-multiplexing film 1 as well as reflecting the S-polarized light supplied from the second wavelength-multiplexing film 2, thereby outputting the combined first to fourth pumping lights through the fifth lens 35 to the light output terminal 25.

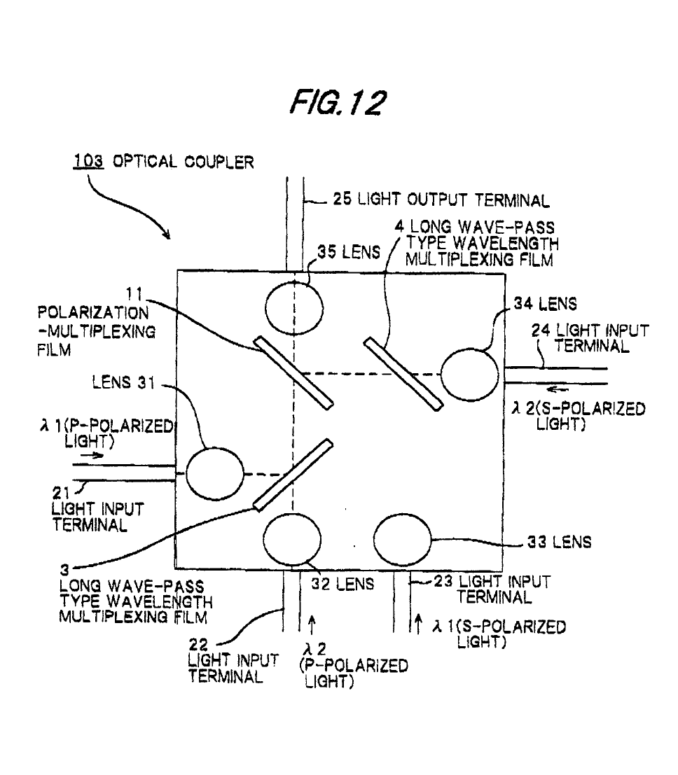

An optical coupler in the third preferred embodiment will be explained in FIGS. 12 to 14. Different from the first and second embodiments, in the third embodiment, two wavelength-multiplexing films having the characteristics that transmits long-wave light as well as reflecting short-wave light is used as described later.

An optical coupler 103 in the third embodiment, as shown in FIG. 12, comprises first to fourth light input terminals 21 to 24 provided with polarization plane holding type optical fibers, first to fourth lenses 31 to 34 provided corresponding to the first to fourth light input terminals 21 to 24, first and second long-wave pass type wavelength-multiplexing films 3, 4, polarization-multiplexing film 11, a light output terminal 25 provided with a single-mode optical fiber, and a fifth lens 35 provided corresponding to the light output terminal 25.

The first to fifth lenses 31 to 35 are collimator lenses for converting incident light into collimated light like those in the second embodiment.

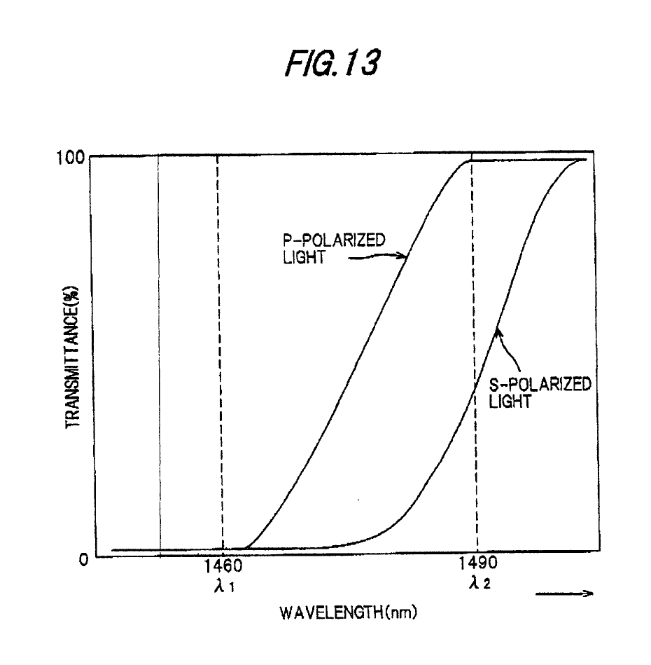

The first long-wave pass type wavelength-multiplexing film 3 is, as so called, a long-wavepass type wavelength-multiplexing means that is, as shown in FIG. 13, effective only for incident light with a wavelength of ^{λ}1=1460 nm and incident light with a wavelength of ^{λ}2=1490 nm as P-polarized lights at an incidence angle of 45°. In detail, as understood from FIG. 13, the first long-wave pass type wavelength-multiplexing film 3 has the characteristics that, at an incidence angle of 45°, P-polarized light with a wavelength of 1460 nm is less than 1% transmitted, P-polarized light with a wavelength of 1490 nm is more than 95% transmitted and S-polarized light with a wavelength of 1490 nm is about 40% transmitted. Thus, the first long-wave pass type wavelength-multiplexing film 3 can effectively conduct the wavelength-multiplexing by reflecting nearly 100% of incident light at 1460 nm as well as transmitting nearly 100% of incident light at 1490 nm only for P-polarized light.

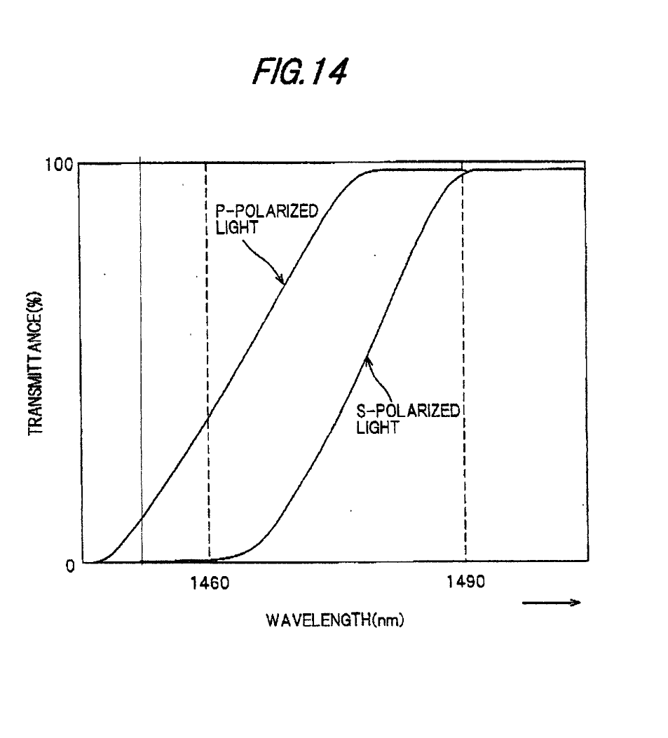

On the other hand, the second long-wave pass type wavelength-multiplexing film 4 is, as so called, a long-wave pass type wavelength-multiplexing means that is, as shown in FIG. 14, effective only for incident light with a wavelength of ^{λ}=1460 nm and incident light with a wavelength of ^{λ}2=1490 nm as S-polarized lights at an incidence angle of 45°. In detail, as understood from FIG. 14, the second long-wave pass type wavelength-multiplexing film 4 has the characteristics that, at an incidence angle of 45°, S-polarized light with a wavelength of 1460 nm is less than 1% transmitted, S-polarized light with a wavelength of 1490 nm is more than 95% transmitted and P-polarized light with a wavelength of 1460 nm is about 40% transmitted. Thus, the second long-wave pass type wavelength-multiplexing film 4 can effectively conduct the wavelength-multiplexing by reflecting nearly 100% of incident light at 1460 nm as well as transmitting nearly 100% of incident light at 1490 nm only for S-polarized light.

The polarization-multiplexing film 11 has such a transmittance wavelength characteristic as shown in FIG. 8 like those in the first and second embodiments.

In the optical coupler 103 in the third embodiment, when first pumping light with a wavelength of 1460 nm (P-polarized light) from the first light input terminal 21, second pumping light with a wavelength of 1490 nm (P-polarized light) from the second light input terminal 22, third pumping light with a wavelength of 1460 nm (S-polarized light) from the third light input terminal 23, and fourth pumping light with a wavelength of 1490 nm (S-polarized light) from the fourth light input terminal 24 are supplied, the first to fourth pumping lights are combined and then output from the light output terminal 25 as explained below. Namely, the first long-wave pass type wavelength-multiplexing film 3 reflects the first pumping light supplied through the first lens 31 as well as transmitting the second pumping light supplied through the second lens 32, thereby wavelength-multiplexing the first and second pumping lights and then outputting the P-polarized combined light to the polarization-multiplexing film 11. The second long-wave pass type wavelength-multiplexing film 4 reflects the third pumping light supplied through the third lens 33 as well as transmitting the fourth pumping light supplied through the fourth lens 34, thereby wavelength-multiplexing the third and fourth pumping lights and then outputting the S-polarized combined light to the polarization-multiplexing film 11. Then, the polarization-multiplexing film 11 transmits the P-polarized light supplied from the first long-wave pass type wavelength-multiplexing film 3 as well as reflecting the S-polarized light supplied from the second long-wave pass type wavelength-multiplexing film 4, thereby outputting the combined first to fourth pumping lights through the fifth lens 35 to the light output terminal 25.

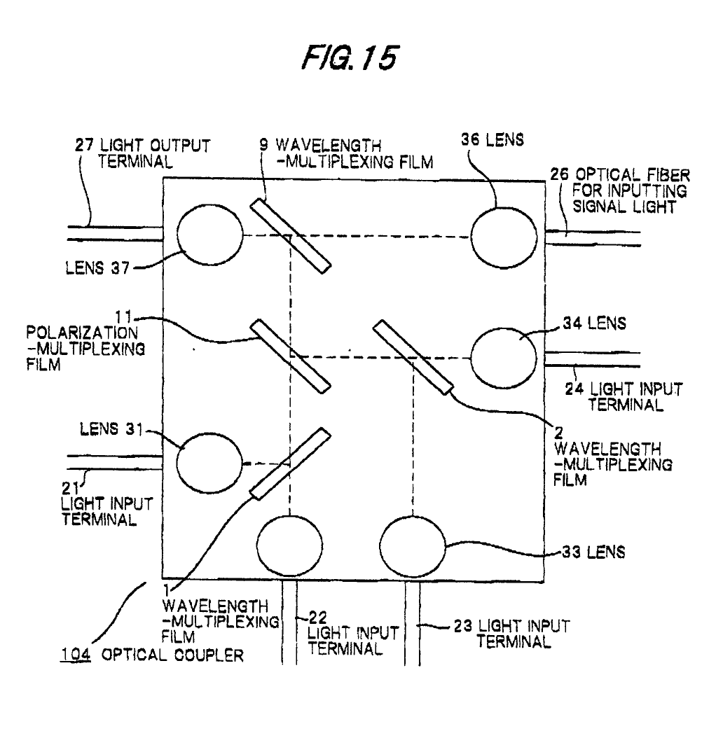

An optical coupler in the fourth preferred embodiment will be explained in FIG. 15. As understood from the comparison between FIGS. 9 and 15, an optical coupler 104 in the fourth embodiment is given by providing the optical coupler 102 in the second embodiment with means for wavelength-multiplexing signal light (wavelength: ^{λ}s) and light emitted from the polarization-multiplexing film 11.

In detail, the optical coupler 104 comprises, as shown in FIG. 15, first to fourth light input terminals 21 to 24 provided with polarization plane holding type optical fibers, first to fourth lenses 31 to 34 provided corresponding to the first to fourth light input terminals 21 to 24, first and second wavelength-multiplexing films 1, 2, polarization-multiplexing film 11, an optical fiber 26 for inputting signal light, a lens 36 provided corresponding to the optical fiber 26, wavelength-multiplexing film 9 for wavelength-multiplexing light to be emitted from the polarization-multiplexing film 11 and signal light to be supplied through the lens 36, a light output terminal 27 for outputting light wavelength-combined by the wavelength-multiplexing film 9, and a lens 37 provided corresponding to the light output terminal 27. Light to be output from the light output terminal 27 is supplied to, e.g., an erbium-doped optical fiber (EDF).

The wavelength-multiplexing film 9 is dielectric multilayer film having the characteristics that incident light is less than 1% transmitted, i.e.. more than 99% reflected, at 1500 nm wavelength and is more than 95% transmitted at 1550 nm wavelength at an incidence angle of 45°.

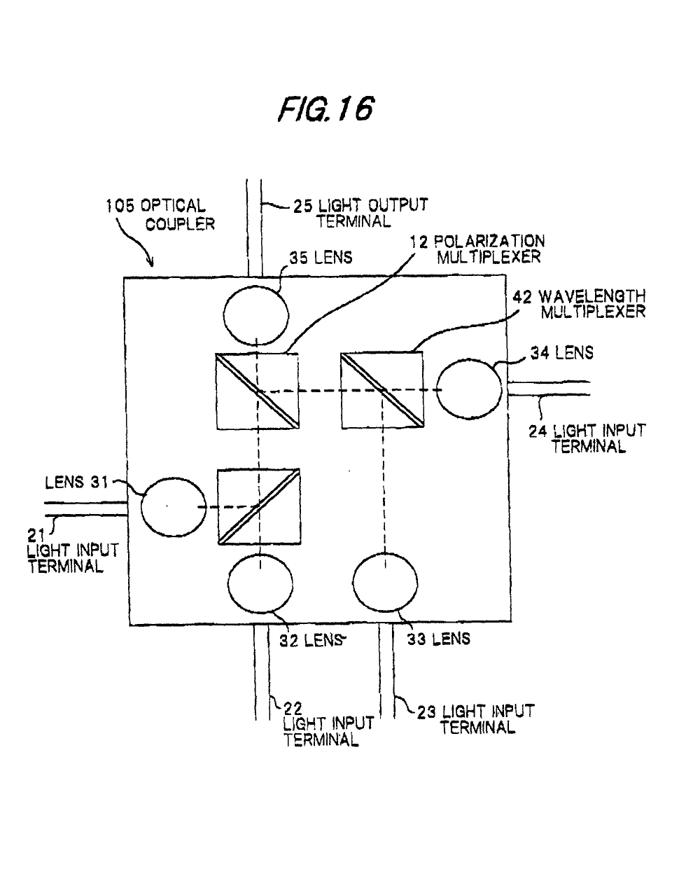

An optical coupler 105 in the fifth preferred embodiment will be explained in FIG. 16. The optical coupler 105 comprises two wavelength-multiplexers 41, 42 and a polarization multiplexer 12 in place of the wavelength-multiplexing film 1 or long-wave pass type wavelength-multiplexing film 3, the wavelength-multiplexing film 2 or long-wave pass type wavelength-multiplexing film 4 and the polarization-multiplexing film 11 shown in FIG. 9 or 12.

In the fifth embodiment, the two wavelength multiplexers 41, 42 are composite prisms that are fabricated by vapor-depositing dielectric multilayer film onto a glass block and further adhering it to another glass block while using an adhesive for refractive-index-matching.

Also, in the fifth embodiment, the polarization multiplexer 12 is a composite prism that is fabricated by vapor-depositing dielectric multilayer film onto a glass block and further adhering it to another glass block while using an adhesive for refractive-index-matching.

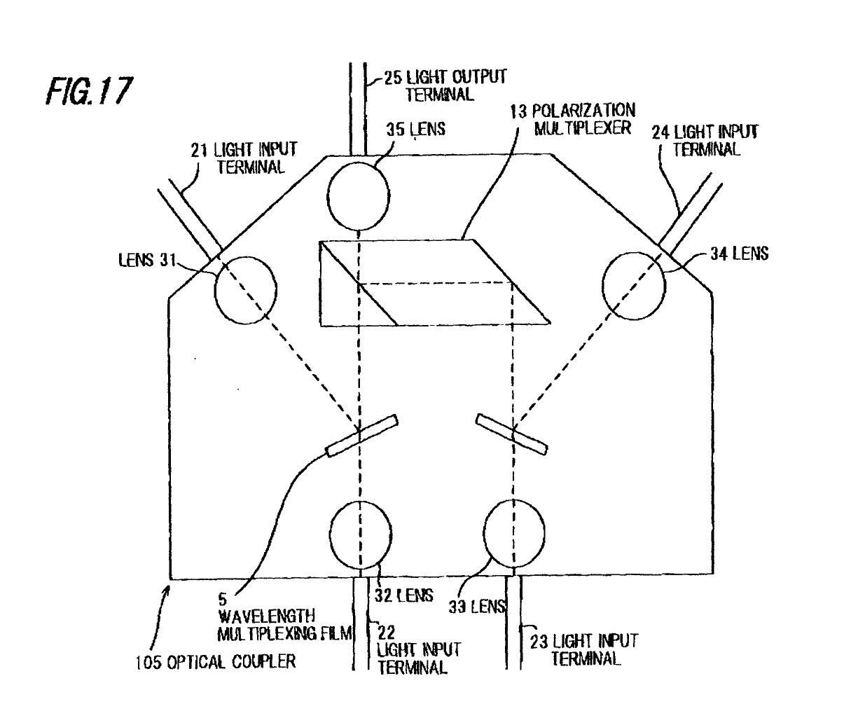

An optical coupler 106 in the sixth preferred embodiment will be explained in FIG. 17. The optical coupler 106 comprises two wavelength multiplexers 5, 6 and a polarization multiplexer 13 in place of the wavelength-multiplexing film 1 or long-wave pass type wavelength-multiplexing film 3, the wavelength-multiplexing film 2 or long-wave pass type wavelength-multiplexing film 4 and the polarization-multiplexing film 11 shown in FIG. 9 or 12.

In the sixth embodiment, the two wavelength-multiplexing films 5, 6 have such a short-wave pass type or long-wave pass type transmittance wavelength characteristic that P-polarized or S-polarized incident light is reflected (transmitted) at 1460 nm wavelength and is transmitted (reflected) at 1490 nm wavelength at a specific incidence angle.

Also, in the sixth embodiment, the polarization multiplexer 13 is a composite prism that is fabricated by vapor-depositing dielectric multilayer film onto a glass block and further adhering it to another glass block while using an adhesive for refractive-index-matching.

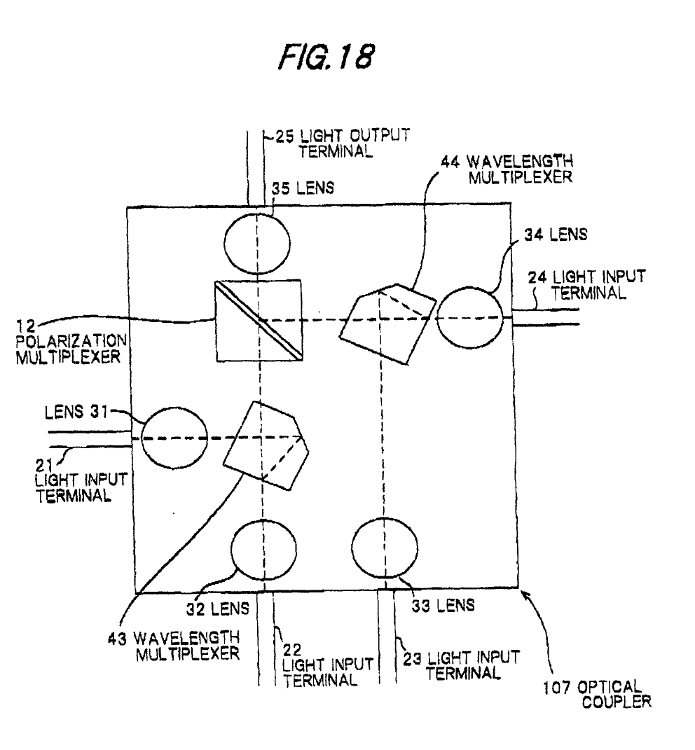

An optical coupler 107 in the seventh preferred embodiment will be explained in FIG. 18. The optical coupler 107 comprises two wavelength multiplexers 43, 44 and a polarization multiplexer 12 in place of the wavelength-multiplexing film 1 or long-wave pass type wavelength-multiplexing film 3, the wavelength-multiplexing film 2 or long-wave pass type wavelength-multiplexing film 4 and the polarization-multiplexing film 11 shown in FIG. 9 or 12.

In the seventh embodiment, the two wavelength multiplexers 43, 44 are prisms that are fabricated by vapor-depositing dielectric multilayer film onto a glass block. They have such a transmittance wavelength characteristic that P-polarized or S-polarized incident light is reflected (transmitted) at 1460 nm wavelength and is transmitted (reflected) at 1490 nm wavelength at a specific incidence angle.

Also, in the seventh embodiment, the polarization multiplexer 12 is identical with the polarization multiplexer 12 in the fifth embodiment.

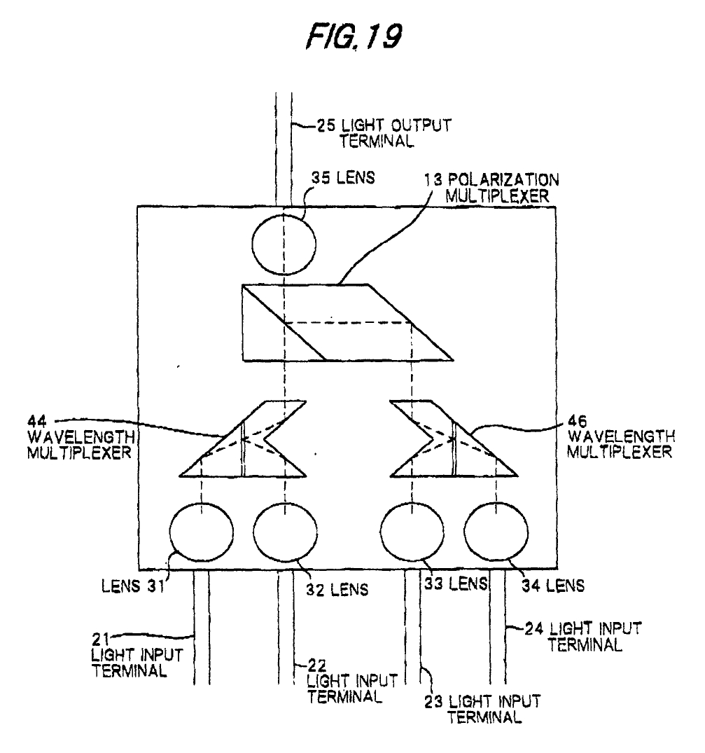

An optical coupler 108 in the eighth preferred embodiment will be explained in FIG. 19. The optical coupler 108 comprises two wavelength multiplexers 45, 46 and a polarization multiplexer 13 in place of the wavelength-multiplexing film 1 or long-wave pass type wavelength-multiplexing film 3, the wavelength-multiplexing film 2 or long-wave pass type wavelength-multiplexing film 4 and the polarization-multiplexing film 11 shown in FIG. 9 or 12.

In the eighth embodiment, the two wavelength multiplexers 45, 46 are composite prisms that are fabricated by vapor-depositing dielectric multilayer film onto a glass block and further adhering it to another glass block while using an adhesive for refractive-index-matching, and they have such a transmittance wavelength characteristic that P-polarized or S-polarized incident light is reflected (transmitted) at 1460 nm wavelength and is transmitted (reflected) at 1490 nm wavelength.

Also, in the eighth embodiment, the polarization multiplexer 13 is identical with the polarization multiplexer 13 in the sixth embodiment.

Although, in the first to eighth embodiments, the wavelength-multiplexing film or wavelength multiplexer and the polarization-multiplexing film or polarization multiplexer are explained as separate parts, they are not limited thereto and can be any device that conducts the wavelength-multiplexing and polarization-multiplexing according to the invention. For example, they may be a composite prism that a wavelength multiplexer and a polarization multiplexer are unified.

Although, in the first to eighth embodiments, the wavelength-multiplexing film or wavelength multiplexer is explained as a short-wave pass type or a ling-wave pass type, it is not limited thereto and can be any device having the transmission or reflection characteristic to two lights with λ₁ and λ₂ wavelengths. For example, it may be a band-pass type wavelength-multiplexing film or wavelength multiplexer. i.e., a so-called band-pass filter.

Furthermore, optical couplers in the invention can, of course, compose an optical fiber amplifier by including an erbium-doped optical fiber.

Although the invention has been described with respect to specific embodiment for complete and clear disclosure, the appended claims are not to be thus limited but are to be construed as embodying all modification and alternative constructions that may be occurred to one skilled in the art which fairly fall within the basic teaching here is set forth.

What is claimed is:

1. An optical coupler, comprising:
a first wavelength-multiplexing means for wavelength-multiplexing first pumping light with a first linear polarization a direction and a first wavelength and second pumping light with said first linear polarization direction and a second wavelength and for outputting first output light with said first linear polarization direction;
a second wavelength-multiplexing means for wavelength-multiplexing third pumping light with a second linear polarization direction orthogonal to said first linear polarization direction and said first wavelength and fourth pumping light with said second linear polarization direction and said second wavelength and for outputting second output light with said second linear polarization direction; and
a polarization-multiplexing means for polarization-multiplexing said first output light output from said first wavelength-multiplexing means and said second output light output from said second wavelength-multiplexing means.

2. An optical coupler, according to claim 1, wherein:
said first wavelength-multiplexing means has the characteristics that light with said first linear polarization direction and said first wavelength or second wavelength can be wavelength-combined and light with said second linear polarization direction and said first wavelength or second wavelength cannot be sufficiently wavelength-combined; and
said second wavelength-multiplexing means has the characteristics that light with said second linear polarization direction and said first wavelength or second wavelength can be wavelength-combined and light with said first linear polarization direction and said first wavelength or second wavelength cannot be sufficiently wavelength-combined.

3. An optical coupler, according to claim 1, wherein:
said first and second wavelength-multiplexing means has any one of the long-wave pass type characteristic that light with longer one of said first and second wavelengths is transmitted and light with the other wavelength is reflected, the short-wave pass type characteristic that light with shorter one of said first and second wavelengths is transmitted and light with the other wavelength is reflected, and the band-pass type characteristic that a predetermined wavelength region to pass light includes either one of said first and second wavelengths.

4. An optical coupler, according to claim 2, wherein:
said first and second wavelength-multiplexing means has any one of the long-wave pass type characteristic that light with longer one of said first and second wavelengths is transmitted and light with the other wavelength is reflected, the short-wave pass type characteristic that light with shorter one of said first and second wavelengths is transmitted and light with the other wavelength is reflected, and the band-pass type characteristic that a predetermined wavelength region to pass light includes either one of said first and second wavelengths.

5. An optical coupler, according to claim 1, wherein:
said first and second wavelength-multiplexing means and said polarization-multiplexing means are provided with a glass plate on which dielectric multilayer film is vapor-deposited.

6. An optical coupler, according to claim 2, wherein;
said first and second wavelength-multiplexing means and said polarization-multiplexing means are provided with a glass plate on which dielectric multilayer film is vapor-deposited.

7. An optical coupler, according to claim 3, wherein:
said first and second wavelength-multiplexing means and said polarization-multiplexing means are provided with a glass plate on which dielectric multilayer film is vapor-deposited.

8. An optical coupler, according to claim 4, wherein:
said first and second wavelength-multiplexing means and said polarization-multiplexing means are provided with a glass plate on which dielectric multilayer film is vapor-deposited.

9. An optical coupler, according to claim 1, wherein:
said first and second wavelength-multiplexing means are provided with a prism on which dielectric multilayer film is vapor-deposited.

10. An optical coupler, according to claim 2, wherein:
said first and second wavelength-multiplexing means are provided with a prism on which dielectric multilayer film is vapor-deposited.

11. An optical coupler, according to claim 3, wherein:
said first and second wavelength-multiplexing means are provided with a prism on which dielectric multilayer film is vapor-deposited.

12. An optical coupler, according to claim 4, wherein;
said first and second wavelength-multiplexing means are provided with a prism on which dielectric multilayer film is vapor-deposited.

13. An optical coupler, according to claim 1, wherein:
said first and second wavelength-multiplexing means are provided with a prism which is composed adhering a glass block on which dielectric multilayer film is vapor-deposited to another glass block by an adhesive for refractive-index matching.

14. An optical coupler, according to claim 2, wherein:
said first and second wavelength-multiplexing means are provided with a prism which is composed adhering a glass block on which dielectric multilayer film is vapor-deposited to another glass block by an adhesive for refractive-index matching.

15. An optical couplers according to claim 3, wherein:
said first and second wavelength-multiplexing means are provided with a prism which is composed adhering a glass block on which dielectric multilayer film is vapor-deposited to another glass block by an adhesive for refractive-index matching.

16. An optical coupler, according to claim 4, wherein:
said first and second wavelength-multiplexing means are provided with a prism which is composed adhering a glass block on which dielectric multilayer film is vapor-deposited to another glass block by an adhesive for refractive-index matching.

17. An optical coupler, according to claim 1, wherein:
said first and second wavelengths are in the range of 1450 nm to 1500 nm.

18. An optical coupler, according to claim 2, wherein:
said first and second wavelengths are in the range of 1450 nm to 1500 nm.

19. An optical coupler, according to claim 3, wherein:
said first and second wavelengths are in the range of 1450 nm to 1500 nm.

20. An optical coupler, according to claim 4, wherein:
said first and second wavelengths are in the range of 1450 nm to 1500 nm.

21. An optical coupler, according to claim 5, wherein:
said first and second wavelengths are in the range of 1450 nm to 1500 nm.

22. An optical coupler, according to claim 9, wherein:
said first and second wavelengths are in the range of 1450 nm to 1500 nm.

23. An optical coupler, according to claim 13, wherein:
said first and second wavelengths are in the range of 1450 nm to 1500 nm.

24. An optical coupler, according to claim 17, wherein:
said first wavelength is around 1460 nm and said second wavelength is around 1490 nm.

25. An optical coupler, according to claim 18, wherein:
said first wavelength is around 1460 nm and said second wavelength is around 1490 nm.

26. An optical coupler, according to claim 19, wherein:
said first wavelength is around 1460 nm and said second wavelength is around 1490 nm.

27. An optical coupler, according to claim 20, wherein:
said first wavelength is around 1460 nm and said second wavelength is around 1490 nm.

28. An optical coupler, according to claim 21, wherein:
said first wavelength is around 1460 nm and said second wavelength is around 1490 nm.

29. An optical coupler, according to claim 22, wherein:
said first wavelength is around 1460 nm and said second wavelength is around 1490 nm.

30. An optical coupler, according to claim 23, wherein:
said first wavelength is around 1460 nm and said second wavelength is around 1490 nm.

31. An optical coupler, according to claim 1, further comprising;
a terminal for inputting signal light; and
a third wavelength-multiplexing means for wavelength-multiplexing said polarization-combined light output from said polarization-multiplexing means and said signal light.

32. An optical coupler, according to claim 2, further comprising:
a terminal for inputting signal light; and
a third wavelength-multiplexing means for wavelength-multiplexing said polarization-combined light output from said polarization-multiplexing means and said signal light.

33. An optical coupler, according to claim 3, further comprising:
a terminal for inputting signal light; and
a third wavelength-multiplexing means for wavelength-multiplexing said polarization-combined light output from said polarization-multiplexing means and said signal light.

34. An optical coupler, according to claim 4, further comprising:
a terminal for inputting signal light; and
a third wavelength-multiplexing means for wavelength-multiplexing said polarization-combined light output from said polarization-multiplexing means and said signal light.

35. An optical coupler, according to claim 5, further comprising:
a terminal for inputting signal light; and
a third wavelength-multiplexing means for wavelength-multiplexing said polarization-combined light output from said polarization-multiplexing means and said signal light.

36. An optical coupler, according to claim 9, further a comprising;
a terminal for inputting signal light; and
a third wavelength-multiplexing means for wavelength-multiplexing said polarization-combined light output from said polarization-multiplexing means and said signal light.

37. An optical coupler, according to claim 13, further comprising:
a terminal for inputting signal light; and
a third wavelength-multiplexing means for wavelength-multiplexing said polarization-combined light output from said polarization-multiplexing means and said signal light.

38. An optical coupler, according to claim 31, wherein:
said first and second wavelengths are in the range of 1450 nm to 1500 nm and said signal light has a 1550 nm band wavelength.

39. An optical coupler, according to claim 32, wherein:
said first and second wavelengths are in the range of 1450 nm to 1500 nm and said signal light has a 1550 nm band wavelength,

40. An optical coupler, according to claim 33, wherein:
said first and second wavelengths are in the range of 1450 nm to 1500 nm and said signal light has a 1550 nm band wavelength.

41. An optical coupler, according to claim 34, wherein:
said first and second wavelengths are in the range of 1450 nm to 1500 nm and said signal light has a 1550 nm band wavelength.

42. An optical coupler, according to claim 35, wherein:
said first and second wavelengths are in the range of 1450 nm to 1500 nm and said signal light has a 1550 nm band wavelength.

43. An optical coupler, according to claim 36, wherein;
said first and second wavelengths are in the range of 1450 nm to 1500 nm and said signal light has a 1550 nm band wavelength.

44. An optical coupler, according to claim 37, wherein:
said first and second wavelengths are in the range of 1450 nm to 1500 and said signal light has a 1550 nm band wavelength.
